(19) United States
(12) Patent Application Publication
(10) Pub. No.: US 2014/0154622 A1
(43) Pub. Date: Jun. 5, 2014

(54) LATEX CARRIER COATING AND METHODS FOR MAKING THE SAME

(71) Applicant: XEROX CORPORATION, Norwalk, CT (US)

(72) Inventors: VALERIE FARRUGIA, Oakville (CA); Paul J. Gerroir, Oakvill (CA); Michael S. Hawkins, Cambridge (CA); Richard P. Veregin, Mississauga (CA); Karen Moffat, Brantford (CA)

(73) Assignee: XEROX CORPORATION, Norwalk, CT (US)

(21) Appl. No.: 13/692,799

(22) Filed: Dec. 3, 2012

(51) Int. Cl. G03G 9/113

(52) U.S. Cl. CPC G03G 9/1133
USPC 430/109.3; 252/500; 430/110.2

(57) ABSTRACT

A carrier coating comprising a metal core and a polymeric coating that may be used to form toner. The carrier coating, through how it is made, exhibits improved coating abilities that may be used to completely coat carrier particles, and thus provide excellent aging performance.

### BACKGROUND

Herein disclosed are embodiments that relate generally to carrier particles comprising a metal core and a polymeric coating that may be used to form toner. More particularly, the embodiments relate to the carrier coating for xerographic carriers which provides complete coverage of the metal core and thus excellent aging performance.

The electrostatographic process, and particularly the xerographic process, involves the formation of an electrostatic latent image on a photoreceptor, followed by development of the image with a developer, and subsequent transfer of the image to a suitable substrate. Numerous different types of xerographic imaging processes are known wherein, for example, insulative developer particles or conductive developer particles are selected depending on the development systems used. It is of great importance that such developer compositions are associated with the appropriate triboelectric charging values as it is these values that enable continued formation of developed images of high quality and excellent resolution. In two component developer compositions, carrier particles are used in charging the toner particles.

The resulting toners can be selected for known electrophotographic imaging and printing processes, including digital color processes, and are especially useful for imaging processes, specifically xerographic processes, which usually require high toner transfer efficiency such as those having a compact machine design without a cleaner or those that are designed to provide high quality colored images with excellent image resolution and signal-to-noise ratio and image uniformity, and for imaging systems wherein excellent glossy images are generated.

Carrier particles in part consist of a roughly spherical core, often referred to as the “carrier core,” which may be made from a variety of materials. The core is typically coated with a resin. This resin may be made from a polymer or copolymer. The resin may have conductive material or charge enhancing additives incorporated into it to provide the carrier particles with more desirable and consistent triboelectric properties. The resin may be in the form of a powder, which may be used to coat the carrier particle. Often the powder or resin is referred to as the “carrier coating” or “coating.”

Various coated carrier particles for use in electrostatographic developers for the development of electrostatic latent images are described in patents. For example, U.S. Pat. No. 3,590,000 discloses carrier particles that may consist of various cores, including steel, with a coating thereover of fluoro-polymers and ter-polymers of styrene, methacrylate, and silane compounds.

One common way of obtaining carrier coating is in the form of powder via emulsion polymerization. This particular method of polymerization has been described in patents, for example, U.S. Pat. Nos. 6,042,981 and 5,290,654, incorporated herein by reference. Emulsion polymerization, yielding excellent control over particle size and size distribution, is most typically accomplished by the continuous or semi-continuous addition of monomer to a suitable reaction vessel containing water. The reaction vessel is provided with stirring means, and also optionally, nitrogen atmosphere and thermostatic control. The polymerization is affected by heating to, for example, between about 40° C. and about 85° C., and with the addition of an appropriate initiator compound, such as ammonium persulfate. The polymer or copolymer powders are isolated by freeze drying in vacuo or by conventional spray drying the residue-free latex. The resulting polymer particle diameter size is, for example, from about 0.1 to about 12.0 microns in volume average diameter, but exhibits excellent friability when blended with a bare carrier core.

To meet the demands of toner performance, such as aging performance, complete coating of the carrier surface is required. It is desirable to coat the carrier as completely as possible to prevent increase in conductivity in aging. The conventional approach is to increase the coating weight, which is undesirable as it increases manufacturing cost and complicates the manufacturing process. Moreover, adding additional coating tends to make particles stick together, which then leads to large surface coating defects when the carrier particles are separated in the screening step. Further, the higher the coating weight the more likely poor flow of the carrier will occur in the kiln, reducing throughput (higher throughput on the kilns has been critical to cost reductions), and increasing the likelihood of coating resin agglomerates which are known to cause print defects. Thus, there is a need for a carrier coating that provides complete carrier coverage.

### BRIEF SUMMARY

Embodiments include a carrier coating for xerographic carriers which provides complete coverage of the metal core and thus excellent aging performance and methods for making the same.

In embodiments, there is provided a latex composition for coating carrier cores comprising: a first monomer; a second monomer; and a conductive filler, wherein the residual monomer of the first monomer and second monomer is less than 0.5 percent by weight of the total weight of the latex composition.

In further embodiments, there is provided a carrier particle comprising: a carrier core; and a carrier coating disposed over the carrier core, wherein the carrier coating comprises a first monomer, a second monomer, and a conductive filler, wherein the total residual monomer is less than 0.5 percent by weight of the total weight of the latex composition. In such embodiments, there is also provided a developer for developing electrostatic latent images, comprising: a toner comprising at least a binder resin; and the carrier particles described above.

In yet further embodiments, there is provided a latex composition for coating carrier cores comprising: cyclohexylmethacrylate; dimethylaminoethylmethacrylate; and a conductive filler, wherein the amount of cyclohexylmethacrylate and dimethylaminoethylmethacrylate is less than 0.5 percent by weight of the total weight of the latex composition.

In other embodiments, there is provided a process for making a latex composition for coating carrier cores comprising: mixing one or more surfactants in de-ionized water to form a surfactant solution; mixing a first monomer, a second monomer and one or more surfactants in de-ionized water to form a monomer solution; combining the specific amounts of the monomer solution with the surfactant solution to form seed particles; and subjecting the combined surfactant solution and monomer solution to semi-continuous emulsion polymerization.

### BRIEF DESCRIPTION OF THE DRAWINGS

FIG. 1 is a graph illustrating the correlation between the percentage of residual CHMA and exposed carrier core;

FIG. 2 are Scanning Electron Microscopy (SEM) images illustrating the surface of a typical carrier prepared with each of four latex samples prepared according to the present embodiments (A=Example 1; B=Example 2; C=Example 3; and D=Example 4);

FIG. 3 is a graph illustrating charge of toners prepared according to the present embodiments in both A-zone and J-zone;

FIG. 4 is a graph illustrating charge of additional toners prepared according to the present embodiments in both A-zone and J-zone; and

FIG. 5 is a graph illustrating relative humidity ratios for toners prepared according to the present embodiments.

### DETAILED DESCRIPTION

In the following description, it is understood that other embodiments may be used and structural and operational changes may be made without departing from the scope of the present embodiments.

The present embodiments relate to coating composition for carrier particles that, in embodiments, provide improved carrier surface coating than conventional carrier coatings. In particular, a polymer latex is used as a carrier coating and the method of making the latex imparts the latex with improved coating coverage.

In general embodiments, a latex resin may be composed of a first and a second monomer composition. Any suitable monomer or mixture of monomers may be selected to prepare the first monomer composition and the second monomer composition. The selection of monomer or mixture of monomers for the first monomer composition is independent of that for the second monomer composition and vise versa. In embodiments, the first monomer composition and the second monomer composition can be the same.

Exemplary monomers for the first and/or the second monomer compositions include, but are not limited to styrene, alkyl acrylate, such as, methyl acrylate, ethyl acrylate, butyl arylate, isobutyl acrylate, dodecyl acrylate, n-octyl acrylate, 2-chloroethyl acrylate; β-carboxy ethyl acrylate (β-CEA), phenyl acrylate, methyl alphachloroacrylate, methyl methacrylate, ethyl methacrylate and butyl methacrylate: butadiene; isoprene; methacrylonitrile; acrylonitrile; vinyl ethers, such as, vinyl methyl ether, vinyl isobutyl ether, vinyl ethyl ether and the like; vinyl esters, such as, vinyl acetate, vinyl propionate, vinyl benzoate and vinyl butyrate; vinyl ketones, such as, vinyl methyl ketone, vinyl hexyl ketone and methyl isopropenyl ketone; vinylidene halides, such as, vinylidene chloride and vinylidene chlorofluoride; N-vinyl indole; N-vinyl pyrrolidone; methacrylate; acrylic acid; methacrylic acid; acrylamide; methacrylamide; vinylpyridine; vinylpyrrolidone; vinyl-N-methylpyridinium chloride; vinyl naphthalene; p-chlorostyrene; vinyl chloride; vinyl bromide; vinyl fluoride; ethylene; propylene; butylenes; isobutylene; and the like, and mixtures thereof. In case a mixture of monomers is used, typically the latex polymer will be a copolymer.

In some embodiments, the first monomer composition and the second monomer composition may independently of each other comprise two or three or more different monomers. The latex polymer therefore can comprise a copolymer. Illustrative examples of such a latex copolymer includes poly(styrene-n-butyl acrylate-β-CEA), poly(styrene-alkyl acrylate), poly(styrene-1,3-diene), poly(styrene-alkyl methacrylate), poly(alkyl methacrylate-alkyl acrylate), poly(alkyl methacrylate-aryl acrylate), poly(aryl methacrylate-alkyl acrylate), poly(alkyl methacrylate), poly(styrene-alkyl acrylate-acrylonitrile), poly(styrene-1,3-diene-acrylonitrile), poly(alkyl acrylate-acrylonitrile), poly(styrene-butadiene), poly(methylstyrene-butadiene), poly(methyl methacrylate-butadiene), poly(ethyl methacrylate-butadiene), poly(propyl methacrylate-butadiene), poly(butyl methacrylate-butadiene), poly(methyl acrylate-butadiene), poly(ethyl acrylate-butadiene), poly(propyl acrylate-butadiene), poly(butyl acrylate-butadiene), poly(styrene-isoprene), poly(methylstyrene-isoprene), poly(methyl methacrylate-isoprene), poly(ethyl methacrylate-isoprene), poly(propyl methacrylate-isoprene), poly(butyl methacrylate-isoprene), poly(methyl acrylate-isoprene), poly(ethyl acrylate-isoprene), poly(propyl acrylate-isoprene), poly(butyl acrylate-isoprene); poly(styrene-propyl acrylate), poly(styrene-butyl acrylate), poly(styrene-butadiene-acrylonitrile), poly(styrene-butyl acrylate-acrylononitrile), and the like.

In embodiments, the first monomer composition and the second monomer composition may be substantially water insoluble, such as, hydrophobic, and may be dispersed in an aqueous phase with adequate stirring when added to a reaction vessel.

The weight ratio between the first monomer composition and the second monomer composition may be in the range of from about 0.1:99.9 to about 50:50, including from about 0,5:99.5 to about 25:75, from about 1:99 to about 10:90.

In specific present embodiments, the latex is generated from the semi-continuous emulsion polymerization of cyclohexylmethacrylate (CHMA) and dimethylaminoethylmethacrylate (DMAEMA) monomers. As disclosed in U.S. Patent Publication No. 2011/0070538, the combination of cyclic aliphatic acrylate and amino charge control monomer exhibits higher performance in combination with polyester toners when compared to polymethyl methacrylate (PMMA) latexes used previously for styrene/acrylate toners. However, it was discovered that such latexes were not stable with time and had unacceptably poor shelf life. The addition of increase surfactant was found to somewhat address the shelf life issue, as disclosed in U.S. patent appln. Ser. No. 13/295,067 filed Nov. 12, 2011 to Vanbesien et al. The present embodiments, have been able to achieve far superior stability and shelf life time through a new process of preparing the latex for the CHMA/DMAEMA carrier coating.

In particular, it was discovered that the percentage of residual CHMA in the latex prepared with semi-continuous emulsion polymerization process influences the coverage of the metal core. In embodiments, the residual monomer of the two or more monomers used to make the latex is to be less than 0.5% for all monomers reacted in the emulsion polymerization process. In such a case, it was found that better carrier coating coverage is achieved by changing the emulsification conditions to lower the residual CHMA.

It is believed that the residual monomer plasticizes the latex and can cause the latex coating to become tacky and aggregated such that it does not spread smoothly over the carrier core. The residual monomer is generally the leftover monomer that has not been reacted into the polymer chain. A factor that influences the amount of residual monomer is the amount of seed used initially for the polymerization. It was discovered by the present inventors that the amount of exposed carrier core decreases as the amount of residual CHMA reduces. Semi-continuous emulsion polymerization is used in which aqueous phase-containing water and surfactant is partitioned allowing for additional surfactant to be added later in the process after seed particles have been generated. As used herein, “seed particles” is defined as the following. In the seeded polymerization process, either an external or an in-situ seed is used. The external seed is generally a very small particle size latex made by the batch polymerization process. This latex can be stored and used as needed as a seed to polymerize and grow larger particle size latex products. The in-situ seed preparation process is the first stage of a continuous polymerization process where water, emulsifiers, chelates and a small portion of the monomer, alone or with a comonomer, are polymerized to form the desired number of seed polymer particles. The amount of monomer used for seed determines the number and size of seed particles formed and the particle growth of the final latex product. The seed, once formed, is followed by a second stage of successive additions of the remaining monomers to be used to form the final latex product. Seed monomers plus additional monomers total 100 parts by weight.

Thus, better coating coverage is achieved by changing the emulsification conditions to lower the residual CHMA. The improved coverage also results in the more stable aging performance for carrier conductivity. The charge and relative humidity sensitivity for the present toners are also improved. Moreover, because increased coating weight is not necessary, cost reductions are also observed.

In embodiments, the amount of residual monomer is less than 0.5 percent by weight of the total weight of the latex composition. In other embodiments, the amount of residual monomer is from about 0.05 to about 0.45 percent by weight of the total weight of the latex composition. In further embodiments, the amount of residual monomer is from about 0.30 to about 0.35 percent by weight of the total weight of the latex composition. The amount of residual monomer is measured by Perkin-Elmer gas chromatography (GC).

In embodiments, the latexes are generated as follows. The polymerization of these latexes occurs in the temperature range from about 10° C. to about 100° C. The polymerization of the latexes is accomplished by heating at an effective temperature such as from about 20° C. to about 90° C., in alternative embodiments, from about 45° C. to 75° C. For the polymerization, there are usually selected known initiators, such as radical initiators capable of initiating a free radical polymerization process. Examples of initiators include water soluble initiators, such as ammonium persulfate, sodium persulfate and potassium persulfate, and organic soluble initiators including organic peroxides and azo compounds including Vazo peroxides, such as VAZO 64™, 2-methyl 2-2′-azobis propanenitrile, VAZO 88™, 2-2′-azobis isobutyramide dehydrate, and combinations thereof. Other water-soluble initiators which may be utilized include azoamidine compounds, for example 2, 2′-azobis(2-methyl-N-phenylpropionamidine) dihydrochloride, 2,2′-azobis[N-(4-chlorophenyl)-2-methylpropionamidine]di-hydrochloride, 2,2′-azobis[N-(4-hydroxyphenyl)-2-methyl-propionamidine]dihydrochloride, 2,2′-azobis[N-(4-amino-phenyl)-2-methylpropionamidine]tetrahydrochloride, 2,2′-azobis[2-methyl-N(phenylmethyl)propionamidine]dihydrochloride, 2,2′-azobis[2-methyl-N-2-propenylpropionamidine]dihydrochloride, 2,2′-azobis[N-(2-hydroxy-ethyl)-2-methylpropionamidine]dihydrochloride, 2,2′-azobis[2(5-methyl-2-imidazolin-2-yl)propane]dihydrochloride, 2,2′-azobis[2-(2-imidazolin-2-yl)propane]dihydrochloride, 2,2′-azobis[2-(4,5,6,7-tetrahydro-1H-1,3-diazepin-2-yl)propane]dihydrochloride, 2,2′-azobis[2-(3,4,5,6-tetrahydropyrimidin-2-yl)propane]dihydrochloride, 2,2′-azobis[2-(5-hydroxy-3,4,5,6-tetrahydropyrimidin-2-yl)propane]dihydrochloride, 2,2′-azobis{2-[1-(2-hydroxyethyl)-2-imidazolin-2-yl]propane}dihydrochloride, combinations thereof, and the like. Suitable initiators are also described in U.S. Pat. No. 8,227,163, which is hereby incorporated by reference in its entirety. Initiators can be added in suitable amounts such as, for example, from about 0.1 to about 8 weight percent of the total weight of monomer to be polymerized, and which amount is determined by the desired molecular weight of the resin. In other embodiments, the initiator is added in an amount of from about 0.2 to about 5 weight percent of the monomers.

In the present embodiments, the polymerization is carried out in partitioned steps to allow additional surfactant to be added later in the process after seed particles have been generated. An aqueous surfactant solution comprising a surfactant in de-ionized water was mixed. Separately, a monomer solution of a first and second monomers was mixed with a surfactant and de-ionized water. In specific embodiments, the first and second monomers are CHMA and DMAEMA. Specific amounts of the monomer solution were combined with the aqueous surfactant solution in a Büchi reactor (commercially available from Büchi AG Uster (Uster, Switzerland)) as seed. In embodiments, the amounts of monomer solution added to the aqueous surfactant solution to form seed particles is from about 0.1 to about 10 percent, or from about 1 to about 9 percent, or from about 1 to about 8 percent. Surfactants may be present in amounts of, for example, or from about 0.01 to about 15 percent, or from about 0.1 to about 5 percent by weight of the total weight of the aqueous surfactant solution. Surfactants may be present in amounts of, for example, or from about 0.05 to about 15 percent, or from about 0,5 to about 10 percent by weight of the total weight of the monomer solution.

The surfactants may include, for example, nonionic surfactants such as dialkylphenoxypoly(ethyleneoxy) ethanol, available from Rhone-Poulenac as IGEPAL CA-210, IGEPAL CA-520, IGEPAL CA-720., IGEPAL CO-890, IGEPAL CO-720™, IGEPAL CO-290., IGEPAL CA-210. An effective concentration of the nonionic surfactant is in embodiments, for example, from about 0.1 to about 5 percent by weight, and preferably from about 0.4 to about 1 percent by weight of monomer, or monomers selected to prepare the copolymer resin of the emulsion. Examples of nonionic surfactants include, but are not limited to, alcohols, acids and ethers, for example, polyvinyl alcohol, polyacrylic acid, methalose, methyl cellulose, ethyl cellulose, propyl cellulose, hydroxylethyl cellulose, carboxy methyl cellulose, polyoxyethylene cetyl ether, polyoxyethylene lauryl ether, polyoxyethylene octyl ether, polyoxyethylene octylphenyl ether, polyoxyethylene oleyl ether, polyoxyethylene sorbitan monolaurate, polyoxyethylene stearyl ether, polyoxyethylene nonylphenyl ether, dialkylphenoxy poly(ethyleneoxy)ethanol, combinations thereof, and the like. In embodiments commercially available surfactants from Rhone-Poulenc such as IGEPAL CA210™, IGEPAL CA-520™, IGEPAL CA720™, IGEPAL C0890™, IGEPAL CO720™, IGEPAL CO290™, IGEPAL CA-210™, ANTAROX 890™ and ANTAROX 897™ can be utilized.

Examples of ionic surfactants include sodium dodecylsulfate (SDS), sodium dodecylbenzene sulfonate, sodium dodecylnaphthalene sulfate, dialkyl benzenealkyl, sulfates and sulfonates, available from Aldrich, NEOGEN R™, NEOGEN SC™ obtained from Kao, and the like. An effective concentration of the anionic surfactant generally employed is, for example, from about 0.1 to about 5 percent by weight, and preferably from about 0.4 to about 1 percent by weight of monomers or monomer used to prepare the copolymer emulsion. Other suitable anionic surfactants include, in embodiments, DOWFAX™ 2A1, an alkyldiphenyloxide disulfonate from The Dow Chemical Company, and/or TAYCA POWER BN2060 from Tayca Corporation (Japan), which are branched sodium dodecyl benzene sulfonates. Combinations of these surfactants and any of the foregoing anionic surfactants may be utilized in embodiments.

Examples of specific cationic surfactants include, but are not limited to, ammoniums, for example, alkylbenzyl dimethyl ammonium chloride, dialkyl benzenealkyl ammonium chloride, lauryl trimethyl ammonium chloride, alkylbenzyl methyl ammonium chloride, alkyl benzyl dimethyl ammonium bromide, benzalkonium chloride, C12, C15, C17 trimethyl ammonium bromides, combinations thereof, and the like. Other cationic surfactants include cetyl pyridinium bromide, halide salts of quaternized polyoxyethylalkylamines, dodecylbenzyl triethyl ammonium chloride, MIRAPOL and ALKAQUAT available from Alkaril Chemical Company, SANISOL (benzalkonium chloride), available from Kao Chemicals, combinations thereof, and the like. In embodiments a suitable cationic surfactant includes SANISOL B-50 available from Kao Corp., which is primarily a benzyl dimethyl alkonium chloride, and the like.

The monomer or monomer mixture is gradually mixed into an aqueous solution of surfactant preferably while maintaining continuous mixing.

As described in U.S. Pat. No. 8,227,163, which is hereby incorporated by reference in its entirety, in forming the emulsions, the starting materials, surfactant, optional solvent, and optional initiator may be combined utilizing any means within the purview of those skilled in the art. In embodiments, the reaction mixture may be mixed at a rate of, for example, about 50 to about 800 revolutions per minute for from about 1 minute to about 72 hours using any mechanical mixing apparatus known in the art. In further embodiments the mixing is performed at a rate of about 300-600 revolutions per minute for about 4 to about 24 hours (although times outside these ranges may be utilized), while keeping the temperature at from about 10° C. to about 100° C., in embodiments from about 20° C. to about 90° C., in other embodiments from about 45° C. to about 75° C., although temperatures outside these ranges may be utilized.

Those skilled in the art will recognize that optimization of reaction conditions, temperature, and initiator loading can be varied to generate vinyl polymers of various molecular weights, and that structurally related starting materials may be polymerized using comparable techniques. The recovery of the polymer particles from the emulsion polymerization can be accomplished by processes known in the art. For example, the emulsion of polymer particles can first be filtered by any suitable material. In another embodiment, a cheese cloth is used. The polymer particles can then be washed, but in a preferred embodiment, the polymer particles are not washed, thus allowing some amount of the surfactant to remain in association with the conductive polymer particles. Allowing some amount of the surfactant to remain in association with the polymer particles provides for better particle formation and better carrier coating characteristics. Once the copolymer utilized as the coating for a carrier has been formed, it may be recovered from the emulsion by any technique within the purview of those skilled in the art, including filtration, drying, centrifugation, spray drying, combinations thereof, and the like. The surfactants' interplay with the surface chemistry of the polymer particles provides for these improved results. Finally, the polymer particles are dried using, e.g., freeze drying, spray drying or vacuum techniques well known in the art.

The polymer particles isolated from the process have an initial size of, for example, from about 10 nanometers to 3 micrometers. Due to physical aggregates, some of the polymer particles may initially have a size larger than 7 micrometer. During the mixing process with the conductive filler and/or the carrier cores, the physical aggregates of the polymer particles will be broken up into smaller polymer particles. Preferably, the polymer particles obtained by the process herein have a size of, for example, from about 30 nanometers to about 1 micrometer, or from about 50 nanometers to about 400 nanometers.

After the formation and recovery of the polymer particles, at least one conductive filler is incorporated with the polymer particles. The inclusion of conductive filler into carrier coating composition is well known in the xerographic arts. Various types of conductive filler may be incorporated into the present embodiments. The conductive material described may be any suitable material exhibiting conductivity, e.g., metal oxides like tin oxide, metals, carbon black, and the like, whose size and surface area provide the proper conductivity range. An exemplary carbon black is VULCAN XC72 (available from Cabot Corporation; Boston, Mass.), which has a particle size of about 0.03 micrometers, and a surface area of about 250 m²/g. The coating composition described herein enables carriers to achieve a wide range of conductivity. Carriers using the composition may exhibit conductivity of from about 10⁻⁷ to about 10⁻¹⁷ mho-cm⁻¹ as measured, for example, across a 0.1 inch magnetic brush at an applied potential of 10 volts; and wherein the coating coverage encompasses from about 10 percent to about 100 percent of the carrier core.

The conductive filler is incorporated into the polymer particles using techniques well known in the art including the use of various types of mixing and/or electrostatic attraction, mechanical impaction, dry-blending, thermal fusion and others. The composition may contain from about 0 percent to about 60 percent by weight conductive filler, although in some embodiments the micro-powder may contain only about 10 percent by weight of a conductive filler.

In addition to incorporating conductive filler into carrier coatings, it is often desirable to impart varying charge characteristics to the carrier particle by incorporating charge enhancing additives. If incorporated with the sub-micron sized polymer particles, the charge enhancing additives may be incorporated in a premixing process before or after the incorporation of the conductive filler.

Typical charge enhancing additives include particulate amine resins, such as melamine, and certain fluoro polymer powders such as alkyl-amino acrylates and methacrylates, polyamides, and fluorinated polymers, such as polyvinylidine fluoride (PVF₂) and poly(tetrafluoroethylene), and fluoroalkyl methacrylates such as 2,2,2, trifluoroethyl methacrylate. Other charge enhancing additives such as, for example, those illustrated in U.S. Pat. No. 5,928,830, incorporated by reference herein, including quaternary ammonium salts, and more specifically, distearyl dimethyl ammonium methyl sulfate (DDAMS), bis-1-(3,5-disubstituted-2-hydroxy phenyl)axo-3-(mono-substituted)-2-naphthalenolato(2-) chromate(1-), ammonium sodium and hydrogen (TRH), cetyl pyridinium chloride(CPC), FANAL PINK™ D4830, and the like and others as specifically illustrated therein may also be utilized in the present embodiments.

The charge additives are added in various effective amounts, such as from about 0.01 percent to about 15.0 percent by weight, based on the sum of the weights of all polymer, conductive additive, and charge additive components.

After the synthesis of the coating composition, including the incorporation of conductive filler and optional charge enhancing additives, the resin may be incorporated onto the surface of the carrier. Various effective suitable processes can be selected to apply a coating to the surface of the carrier particles. Examples of typical processes for this purpose include roll mixing, tumbling, milling, shaking, electrostatic powder cloud spraying, fluidized bed, electrostatic disc processing, and an electrostatic curtain. For example, see U.S. Pat. No. 6,042,981, incorporated herein by reference.

Following incorporation of the coating composition onto the surface of the carrier, heating may be initiated to permit flow of the coating material over the surface of the carrier core. In a preferred embodiment, the coating composition is fused to the carrier core in either a rotary kiln or by passing through a heated extruder apparatus.

In an embodiment, the conductive polymer particles are used to coat carrier cores of any known type by any known method, which carriers are then incorporated with any known toner to form a developer for xerographic printing. Suitable carriers may be found in, for example, U.S. Pat. Nos. 4,937,166 and 4,935,326, incorporated herein by reference, and may include granular zircon, granular silicon, glass, steel, nickel, ferrites, magnetites, iron ferrites, silicon dioxide, and the like.

Carrier cores having a diameter in a range of, for example, about 30 micrometers to about 400 micrometers may be used. In further embodiments, the carriers are, for example, about 35 micrometers to about 100 micrometers.

Typically, the coating composition covers, for example, about 10 percent to about 100 percent, or from about 50 percent to about 100 percent, or from about 80 percent to about 100 percent of the surface area of the carrier core using from about 0.1 percent to about 20 percent coating weight, or from about 0.5 percent to about 10 percent coating weight, or from about 0.7 percent to about 5 percent coating weight.

The coating composition of the present embodiments finds particular utility in a variety of xerographic copiers and printers, such as high speed xerographic color copiers, printers, digital copiers and more specifically, wherein color copies with excellent and substantially no background deposits are desirable in copiers, printers, digital copiers, and the combination of xerographic copiers and digital systems.

### EXAMPLES

The examples set forth hereinbelow are being submitted to illustrate embodiments of the present disclosure. These examples are intended to be illustrative only and are not intended to limit the scope of the present disclosure. Also, parts and percentages are by weight unless otherwise indicated. Comparative examples and data are also provided.

### Example I

CHMA Latex with 1% DMAEMA—Process Using 2% Seed

A latex emulsion comprised of polymer particles generated from the emulsion polymerization of cyclohexylmethacrylate (CHMA) and dimethylaminoethylmethacrylate (DMAEMA) charge control monomer with partitioned surfactant were prepared as follows:

A surfactant solution consisting of 1.11 mmoles (0.320 g) sodium lauryl sulfate (anionic emulsifier) and 14.05 moles (253 g) of de-ionized water was prepared by mixing at 800 RPM for 20 minutes in a 500 ml beaker. The aqueous surfactant solution was then transferred into a 1 L Büchi reactor. The reactor was heated up to 65° C. at a controlled rate and continuously purged with nitrogen while being stirred at 450 RPM.

In another 500 ml beaker 665.7 mmol (112 g) of CHMA was weighed and 1% DMAEMA or 6.7 mmol (1.053 g) of DMAEMA was added to the CHMA. To this monomer solution was added 2.43 mmol (0.701 g) of sodium lauryl sulfate surfactant and 7.085 moles (128 g) of de-ionized water. The contents in the beaker were stirred at 800 RPM to emulsify the monomer/aqueous surfactant solution.

Two percent by weight (4.84 g) of this monomer/aqueous solution was added to the aqueous surfactant mixture in the Büchi reactor as a seed. Separately prepared was a solution of 2.1 mmol (0.479 g) ammonium persulfate initiator dissolved in 222 mmol (4.00 g) de-ionized water to form the initiator solution. The initiator solution was then slowly charged into the reactor via pipette. After 40 minutes of the Büchi stirring at 450 RPM and 65° C., the contents from the beaker containing the rest of the monomer/aqueous solution were slowly metered in using a Fluid Metering Inc. (FMI) metering pump at a rate of 0.9 g per minute. Once all the monomer emulsion was charged into the Büchi, the temperature was held at 65° C. for an additional 3 hours to complete the reaction. Full cooling was applied to the reactor to bring the temperature to below 35° C. A liquid sample was taken to measure particle size on a Nanotrac Particle Size Analyzer (Microtrac), zeta potential on a Zetasizer (Malvern) and evaluation of residual monomer by a Perkin-Elmer gas chromatography (GC). The rest of the product was dried to a powder form using a freeze-drier apparatus.

### Example 2

CHMA Latex with 1% DMAEMA—Process Using 4% Seed

Procedure was identical to Example 1 except that four percent by weight (9.67 g) of this monomer/aqueous solution was added to the aqueous surfactant mixture in the Büchi reactor as a seed.

### Example 3

CHMA Latex with 1% DMAEMA—Process Using 6% Seed

Procedure was identical to Example 1 except that six percent by weight (14.51 g) of this monomer/aqueous solution was added to the aqueous surfactant mixture in the Büchi reactor as a seed.

### Example 4

CHMA Latex with 1% DMAEMA—Process Using 8% Seed

Procedure was identical to Example 1 except that eight percent by weight (19.34 g) of this monomer/aqueous solution was added to the aqueous surfactant mixture in the Büchi reactor as a seed.

Evaluation of Residual Monomer

Residual monomer data was calculated for emulsion polymerization experiments by gas chromatography (GC) using a Perkin-Elmer XL Autosystem GC equipped with a flame ionization detector and Supelcowax 10 column (15 m×0.53 mm ID; 0.5 μm film). The signal produced by the detector is unique for each monomer and must be compared to a known sample for identification and quantification. Standards (CHMA, DMAEMA) were prepared in tetrahydrofuran (THF) in a concentration which fell in the linear range of the detector response. Samples were weighed and dissolved in a compatible organic solvent by shaking the vial for about 30 minutes in order to extract the volatile components. Standards and samples were then transferred to GC vials. The latex, containing approximately 20% solids in water, was diluted quantitatively 1 to 10 with solvent (THF), and 50 μl of solvent portion containing residual monomer was injected into the instrument by means of a hypodermic syringe. To obtain vaporization of the volatile components, the temperature of the injector block was increased. The resulting gas chromatogram represents the residual CHMA present in the latex.

### Example 5

Preparation of Carrier and Developer

In a 250 ml PE bottle was added 120 grams of a 35 micron ferrite core (carrier core) and 1.44 grams of the carrier polymer latex. The bottle was then sealed and loaded into a J-zone Turbula mixer (commercially available from Willy A. Bachofen AG Maschinenfabrik (Basel, Switzerland)). The Turbula mixer was run for 45 minutes to disperse powders onto carrier core particles. Next the Haake mixer (commercially available from Thermo Electron (USA)) was setup with the following conditions: set temp 200° C. (all zones), 30 minute batch time, 30 RPM with high shear rotors. After the Haake reaches temperature, the mixer rotation was started and the blend was transferred from the Turbula into the Haake mixer. After 30 minutes, the carrier was discharged from mixer and sieved through a 45 um screen.

Microscopy and Determination of Coating Coverage

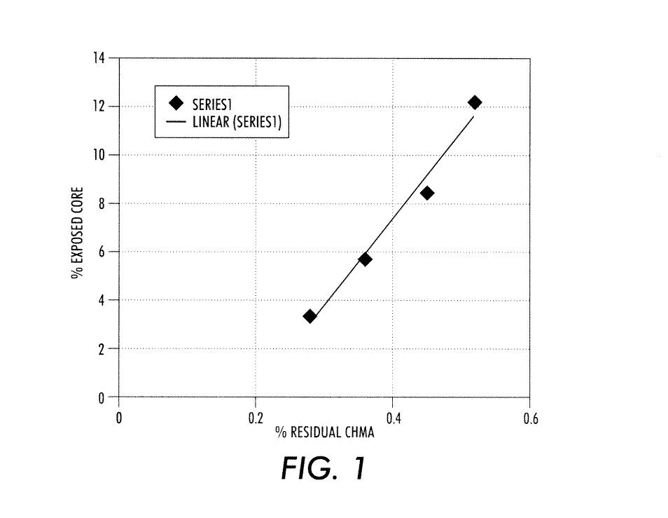

The carrier samples were examined using a Hitachi SU8000 scanning electron microscope. The following images were acquired in such a way as to highlight areas of exposed core, which in the micrographs appear brighter relative to the latex coating. Using Image-Pro® Plus software (commercially available from Media Cybernetics, Inc. (Rockville, Md.)) determinations were made from these images of the percent exposed core. The data contained in Table 1 and FIG. 1 shows a good correlation between the percentage of residual CHMA and exposed core. The amount of residual DMAEMA was negligible or not detected.

TABLE 1

| | % CHMA | % Exposed |
|---|---|---|
| Sample ID | Residual | Core |
| Example 1 - 2% seed | 0.52 | 12.2 |
| Example 2 - 4% seed | 0.45 | 8.5 |
| Example 3 - 6% seed | 0.28 | 3.4 |
| Example 4 - 8% seed | 0.36 | 5.7 |

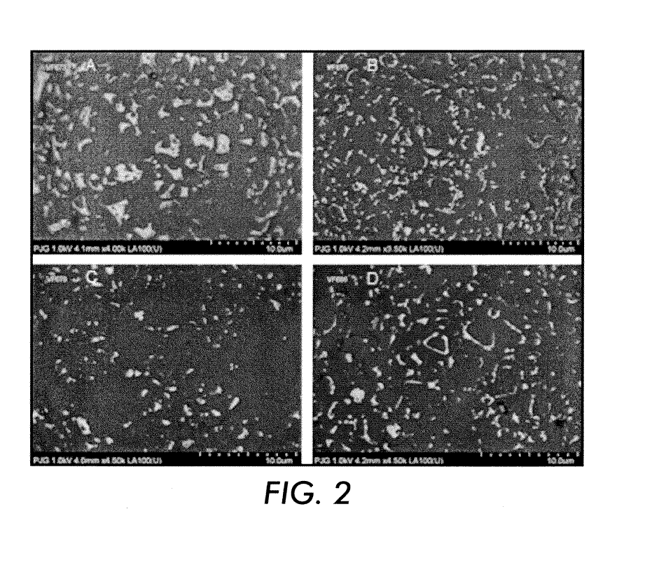

FIG. 2 are Scanning Electron Microscopy (SEM) images illustrating the surface of a typical carrier prepared with each of four latex samples for the four examples (A=Example 1; B=Example 2; C=Example 3; and D=Example 4). The bright areas correspond to the exposed core, the darker regions latex coating. It is expected that better coating coverage will improve stability to aging performance.

Charging Data

Toner charging results using these carriers were obtained by preparing a developer at 5% toner concentration using a XEROX 700 toner, both parent and that blended with toner additives. Carrier weight was 10 grams. After conditioning samples a minimum of 48 hours for J-zone (at about 21.1° C. and 10% RH), and a minimum 24 hours for A-zone (at about 28° C./85% relative humidity), the developers were charged in a Turbula mixer 10 mins for parent developer and 60 minutes for the additive developer. The toner charge was measured in the form of q/d, the charge to diameter ratio. The q/d was measured using a charge spectrograph. A-zone samples are measured with 100 V/cm and J-zone samples are measured with 50 V/cm field, and are measured visually as the midpoint of the toner charge distribution. The charge was reported in millimeters of displacement from the zero line, corrected to 100 V/cm (2×the 50 V/cm values). The final mm displacement can be converted to femtocoulombs/micron (fC/μm) by multiplying by 0.092.

The toner charge per mass ratio (Q/M) was also determined by the total blow-off charge method, measuring the charge on a faraday cage containing the developer after removing the toner by blow-off in a stream of air. The total charge collected in the cage is divided by the mass of toner removed by the blow-off, by weighing the cage before and after blow-off to give the Q/M ratio.

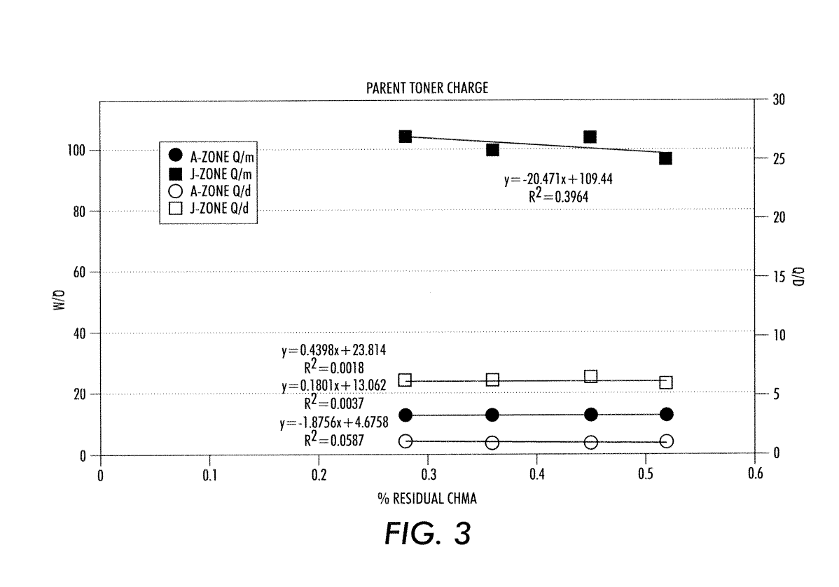

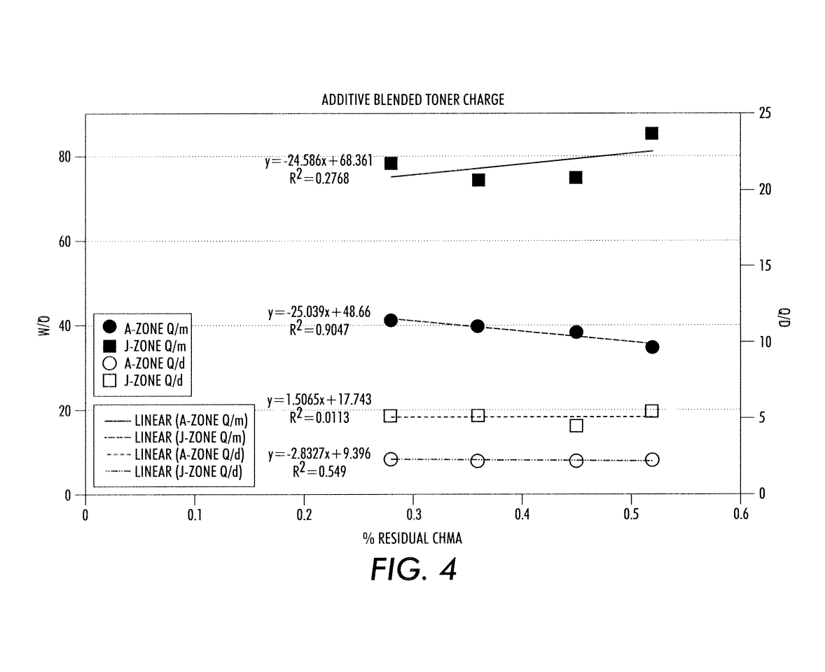

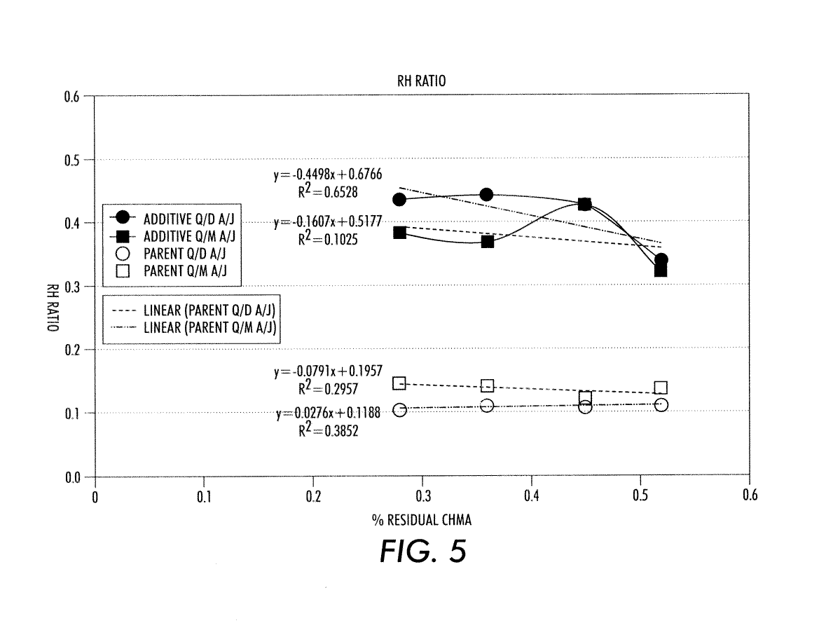

In general, performance of all carriers was relatively similar. Overall, parent toner charge in both A-zone and J-zone was equal or higher as the amount of residual CHMA was reduced as shown in FIG. 3. A-zone blended toner charge was significantly increased with lower residual CHMA as shown in FIG. 4. Blended toner in J-zone had a more complicated dependence, but aside from the highest amount of residual CHMA, also trended somewhat higher with reduction in residual CHMA. RH ratios improved slightly for parent toners as shown in FIG. 5, but were much better for blended toners with reduced residual CHMA. In general, overall charge and RH performance was clearly improved by reduced residual CHMA.

It will be appreciated that various of the above-disclosed and other features and functions, or alternatives thereof, may be desirably combined into many other different systems or applications. Various presently unforeseen or unanticipated alternatives, modifications, variations or improvements therein may be subsequently made by those skilled in the art which are also intended to be encompassed by the following claims.

1. A latex composition for coating carrier cores comprising:
a first monomer;
a second monomer; and
a conductive filler, wherein a total residual monomer is less than 0.5 percent by weight of the total weight of the latex composition.

2. The latex composition of claim 1, wherein the first monomer is cyclohexylmethacrylate.

3. The latex composition of claim 1, wherein the second monomer is dimethylaminoethylmethacrylate.

4. The latex composition of claim 1 being generated from a semi-continuous emulsion polymerization of the first and second monomers.

5. The latex composition of claim 1 further comprising one or more change enhancing additives.

6. A carrier particle comprising:
a carrier core; and
a carrier coating disposed over the carrier core, wherein the carrier coating comprises a latex composition comprising
a first monomer being an aliphatic cycloacrylate,
a second monomer being a dialkylmethacrylate, and
a conductive filler, wherein a total residual monomer of the first and second monomer is less than 0.5 percent by weight of the total weight of the latex composition.

7. The carrier particle of claim 6, wherein the carrier core comprises a material selected from the group consisting of granular zircon, granular silicon, glass, steel, nickel, ferrites, magnetites, iron ferrites, silicon dioxide, and mixtures thereof.

8. The carrier particle of claim 6, wherein the carrier core has a diameter in the range of from about 30 micrometers to about 400 micrometers.

9. The carrier particle of claim 6, wherein the carrier coating covers from about 50 percent to about 100 percent of the surface area of the carrier core.

10. The carrier particle of claim 9, wherein the carrier coating covers from about 80 percent to about 100 percent of the surface area of the carrier core.

11. A developer for developing electrostatic latent images, comprising:
a toner comprising at least a binder resin; and
carrier particles of claim 6.

12. The developer of claim 11, wherein the binder resin is a vinyl polymer resin.

13. The developer of claim 11, wherein the toner is an emulsion aggregation toner.

14. The developer of claim 11, wherein the toner further comprises one or more amorphous resins.

15. A latex composition for coating carrier cores comprising:
cyclohexylmethacrylate;
dimethylaminoethylmethacrylate; and
a conductive filler, wherein the amount of cyclohexylmethacrylate and dimethylaminoethylmethacrylate is less than 0.5 percent by weight of the total weight of the latex composition.

16. (canceled)

17. (canceled)

18. (canceled)

19. (canceled)

20. (canceled)

21. The carrier particle of claim 6, wherein the latex composition further comprises one or more charge enhancing additives.
